(19) United States
(12) Patent Application Publication
(10) Pub. No.: US 2004/0131260 A1
(43) Pub. Date: Jul. 8, 2004

(54) Method and apparatus for support and/or conversion of two image formats

(76) Inventor: Fisseha Mekuria, Lund (SE)

Correspondence Address: BURNS DOANE SWECKER & MATHIS L L P, POST OFFICE BOX 1404, ALEXANDRIA, VA, 22313-1404, US

(21) Appl. No.: 10/469,138

(22) PCT Filed: Mar. 11, 2002
(86) PCT No.: PCT/EP02/02752

(51) Int. Cl. G06K 9/36

(52) U.S. Cl. 382/232

(57) ABSTRACT

This invention relates to a method of supporting a first and a second image format, the method comprising the steps of obtaining image data in the first image format or in the second image format from a compressed image, and deriving relevant information on the basis of the obtained image data, where the method further comprises the step of applying a base function to at least part of the obtained image using at least part of the derived relevant information, where the base function is a function common to both the first and the second image format. In this way a single transform may support two different compressed image formats having certain similarities like the JPEG and JPEG2000 without having to implement separate individual support for each format. Additionally, backward compatibility to earlier JPEG standard is obtained in a very simple way while maintaining compatibility with the newer JPEG2000 standard.

The present invention relates to a method of supporting a first and a second image format, the method comprising the steps of

obtaining image data in the first image format or in the second image format from a compressed image, and

deriving relevant information on the basis of the obtained image data.

The present invention also relates to a method of converting between a first and a second image format, the method comprising the steps of

obtaining image data in the first image format from a compressed image, and

deriving relevant information on the basis of the obtained image data.

The present invention also relates to an apparatus for supporting a first and a second image format, the apparatus comprising

receiving means for receiving image data in the first image format or in the second image format from a compressed image, and

processing means for deriving relevant information on the basis of the obtained image data.

Additionally, the invention relates to a computer system for performing the method according to the invention and a computer readable-medium comprising a program, which may cause one or more computers to perform the method of the present invention.

Various image file formats exist for compressed image data, which reduces the size of the file normally at the expense of little or no noticeable loss of image quality.

Picture coding and transmission will be a main application area for the coming 3G systems. The current standard for picture coding is the so-called JPEG (Joint Picture Experts Group) and is widely used as a compression and decoding scheme for storage and transmission of picture signal. JPEG is based on the discrete cosine transform (DCT) algorithm for compression of image signals, see e.g. Multirate Systems & Filter-banks, P. P. Vaidyanathan, Prentice Hall, 1993, incorporated herein by reference.

Additionally, a new image compression algorithm is being standardised, which has some advantages in comparison to the JPEG standard such as error resilience, which is more applicable for, e.g. mobile, transmission. This so-called JPEG2000 algorithm, see e.g. Complexity of JPEG Still Image CODEC for Mobile Applications, F. Mekuria TWE/U 98:065, incorporated herein by reference, is based on a discrete wavelet transform (DWT), see e.g. JPEG2000 Image Coding Systems, ISO Final committee draft Version 1.0, March 2000, incorporated herein by reference.

The JPEG2000 has better image quality and better compression grade than JPEG at the expense of requiring additional computational complexity and time due to the use of a wavelet function instead of cosine functions.

In order to restore a JPEG or JPEG2000 compressed image the inverse DCT (IDCT) or the inverse DWT (IDWT) is used, respectively.

$$IDCT \text{:}$$

$${\hat{Y}}_{m , n} = \frac{4}{{N}^{2}} {\sum }_{p = 0}^{N - 1} {\sum }_{q = 0}^{N - 1} {α}_{q} {α}_{p} {U}_{p , q} cos \frac{π ( 2 m + 1 ) p}{2 N} cos \frac{π ( 2 n + 1 ) q}{2 N} ;$$

Here U_{p,q} is the compressed image information, i.e. transform coefficients of the N×N point DCT transform, p and q are indices of the transform coefficients U_{p,q}, aq and αₚ are constants determined by U_{p,q}, N is the size of the N×N DCT transform, n the index/coordinate along one axis of the restored image, m the index/coordinate along the other axis, and Y_{m,n} the restored image. A Huffman coder may be applied on the transform coefficients to quantify and bit pack them in order to prepare them for transmission.

If the length is not equal to the height the inverse transform would have 4/(N*M) instead of 4/N\hat{ }2 where N is the length and M is the height of the picture/image and one of the sums would go to M−1 instead of N−1.

$$IDWT \text{:}$$

$$y ( p , q ) = {\sum }_{p = 0}^{N - 1} {\sum }_{q = 0}^{N - 1} {U}_{DWT} ( p , q ) {a}^{- \frac{p}{2}} f ( {a}^{- p} t - qT ) .$$

Here U_{DWT}(p,q) is the compressed image information, i.e. the N×N DWT coefficients, p and q are indices of the DWT transform coefficients U_{DWT}, a^{-p/2} is a constant determined by U_{DWT} (p,q), N is the size of the N×N DWT transform, f( . . . ) a wavelet function, and y(p,q) the restored image.

However, since that the JPEG standard has been popularly and widespread used many stored images and equipment use it as the algorithm of choice thereby making it difficult to use the pictures and equipment according to the JPEG2000 standard, especially for equipment which not normally easy upgradeable.

Another problem is that since most compressed images are stored in JPEG a device has at least in a transition period to be able to support both formats, which requires direct support of both formats thereby increasing the complexity, memory need, power consumption, etc.

The object of the invention is to provide a method with the possibility of supporting both the JPEG and JPEG2000 image compression standards or two or more image formats having at least some things in common with respect to decompression.

Another object is to provide a method with low complexity image decoding, which is especially useful in portable apparatuses typically having a relatively limited power supply and computational capability.

Yet another object is to provide a method with backward compatibility to earlier JPEG standard images.

These objects are achieved by a method of supporting a first and a second image format of the aforementioned kind, which further comprises the step of

applying a base function to at least part of the obtained image using at least part of the derived relevant information, where the base function is a function common to both the first and the second image format.

Hereby, a method that supports at least two image formats are obtained while only having implemented one base function, which even may be optimized for this specific task. Since only a single base function needs to be implemented/used memory usage and thereby power consumption is reduced. Additionally, the base function may also be simpler than one of the normally used inverse functions/transforms for one of the image formats thereby reducing complexity, the needed amount of calculation (MIPS) and power usage even further. This is e.g. the case for one format being JPEG2000 and a suitable base function, since the use of IDWT is avoided.

In accordance with one embodiment of the method, the first format and/or second format is selected from the group of: JPEG and JPEG2000.

In accordance with another embodiment, the step of deriving relevant information comprises at least one of

deriving at least one constant on the basis of the obtained image data, and

deriving at least one table on the basis of the obtained image data.

Hereby, very only simple information needs to be derived as input for the base function.

In a preferred embodiment, the step of deriving relevant information comprises deriving information relating to the inverse transform according to the first and/or second format.

In a preferred embodiment

the format of the image is JPEG being able to be decoded by the inverse discrete cosine transform (IDCT),

the step of deriving relevant information comprises deriving at least one constant using the constant parts of the IDCT and the image data, and deriving a table using the cosine parts of the IDCT and the image data.

Hereby, an image in JPEG format may be decoded using the base function where the need for calculating the complete IDCT is avoided.

In another preferred embodiment

the format of the image is JPEG2000 being able to be decoded by the inverse discrete wavelet transform (IDWT),

the step of deriving relevant information comprises deriving at least one constant using the constant parts of the IDWT and the image data, and deriving a table using the wavelet function part(s) of the IDWT and the image data.

Hereby, an image in JPEG2000 format may be decoded using the base function where the need for calculating the complete IDWT is avoided.

In a preferred embodiment the base function is done by applying two sums one from index 0 to N−1 and one from index 0 to M−1 on the at least one derived constant, the derived table, and the image data, where N and M is equal to the length and the height of image, respectively.

Hereby, a very simple base function is obtained reducing complexity, memory and/or power consumption.

Another object of the invention is to provide a method, which advantageously converts between two compressed image formats in a simple manner.

This object is achieved by a method of converting between a first and a second image format of the aforementioned kind, where the step of deriving relevant information comprises

deriving at least one first constant according to the inverse transform of the first image format and using the image data, and

deriving at least one first table according to the inverse transform of the first image format, and the method further comprises the step of

deriving at least one second constant according to the inverse transform of the second image format and using the at least one first constant,

and deriving at least one second table according to the inverse transform of the second image format using the at least one first table.

In this way, it is not necessary to decode the image/image file in the first format completely into an uncompressed image and then code the uncompressed image into the second format, since an image in the second format is calculated directly from the image in the first format using the similarities in the format's respective inverse functions. This reduces the complexity of the system/method and avoids transcoding, which could degrade the image quality.

In a preferred embodiment,

the first image format is JPEG and the second image format is JPEG2000, or

the first image format is JPEG2000 and the second image format is JPEG.

In this way conversion from JPEG to JPEG2000 or conversion from JPEG2000 to JPEG are obtained.

In one embodiment, the method is used in a portable device.

In a preferred embodiment, the method is used in a mobile telephone.

Another object of the invention is to provide an apparatus that supports both the JPEG and JPEG2000 image compression standards in a very simple manner.

Another object is to provide an apparatus with low complexity image decoding, which is especially useful in portable apparatuses with typically a relatively limited power supply and computational capability.

Yet another object is to provide an apparatus with backward compatibility to earlier JPEG standard images.

These objects are achieved by an apparatus of the aforementioned kind, where the processing means further is adapted to

apply a base function to at least part of the obtained image using at least part of the derived relevant information, where the base function is a function common to both the first and the second image format.

In one embodiment, the first format and/or second format is selected from the group of: JPEG and JPEG2000.

In one embodiment, the processing means is adapted to derive relevant information by

deriving at least one constant on the basis of the obtained image data, and/or

deriving at least one table on the basis of the obtained image data.

In one embodiment, the processing means is adapted to derive relevant information by deriving information relating to the inverse transform according to the first and/or second format.

In one embodiment,

the format of the image is JPEG being able to be decoded by the inverse discrete cosine transform (IDCT), and

the processing means is adapted to derive at least one constant using the constant parts of the IDCT and the image data, and deriving a table using the cosine parts of the IDCT and the image data.

In one embodiment,

the format of the image is JPEG2000 being able to be decoded by the inverse discrete wavelet transform (IDWT), and

the processing means is adapted to derive at least one constant using the constant parts of the IDWT and the image data, and deriving a table using the wavelet function part(s) of the IDWT and the image data.

In one embodiment, the base function is done by applying two sums one from index 0 to N−1 and one from index 0 to M−1 on the at least one derived constant, the derived table, and the image data, where N and M is equal to the length and the height of image, respectively.

The invention also relates to an apparatus for converting between a first and a second image format, the apparatus comprising

receiving means for obtaining image data in the first image format from a compressed image, and

processing means for deriving relevant information on the basis of the obtained image data, where the processing means further is adapted to

derive at least one first constant according to the inverse transform of the first image format and using the image data,

derive at least one first table according to the inverse transform of the first image format,

derive at least one second constant according to the inverse transform of the second image format and using the at least one first constant, and

derive at least one second table according to the inverse transform of the second image format using the at least one first table.

In one embodiment,

the first image format is JPEG and the second image format is JPEG2000, or

the first image format is JPEG2000 and the second image format is JPEG.

The apparatus and embodiments thereof correspond to the random number generator and embodiments thereof and have the same advantages for the same reasons why they are not described again.

Further, the invention relates to a computer-readable medium having stored thereon instructions for causing a processing unit or a computer system to execute the method described above and in the following. A computer-readable medium may e.g. be a CD-ROM, a CD-R, a DVD RAM/ROM, a floppy disk, a hard disk, a smart card, a network accessible via a network connection, a ROM, RAM, and/or Flash memory, etc. or generally any other kind of media that provides a computer system with information regarding how instructions/commands should be executed.

Hereby, when a computer is caused to retrieve electronic information—as a consequence of the contents of a computer-readable medium as described above—the advantages mentioned in connection with the corresponding method according to the invention are achieved.

Finally, the invention relates to a computer system comprising means adapted to execute a program, where the program, when executed, causes the computer system to perform the method according to the invention thereby obtaining the above mentioned advantages and/or effects.

By computer system is meant e.g. a system comprising one or more processor means, like a specialised or general purpose CPU or the like, which may be programmed/instructed at one time or another in such a way that the computer executes the method according to the invention fully or in part.

The present invention will now be described more fully with reference to the drawings, in which

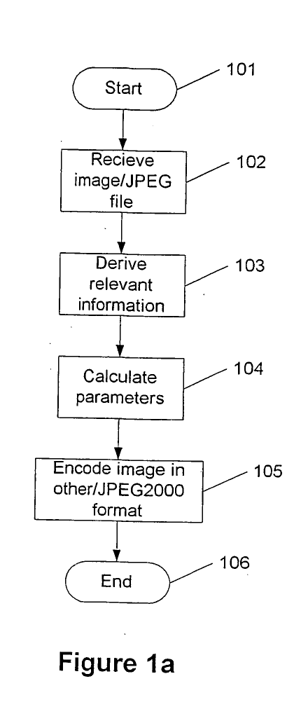

FIG. 1a shows a flow chart of an embodiment of the method according to the present invention illustrating conversion from JPEG to JPEG2000 as an example;

FIG. 1b shows a flow chart of another embodiment of the method according to the present invention illustrating conversion from JPEG2000 to JPEG as an example;

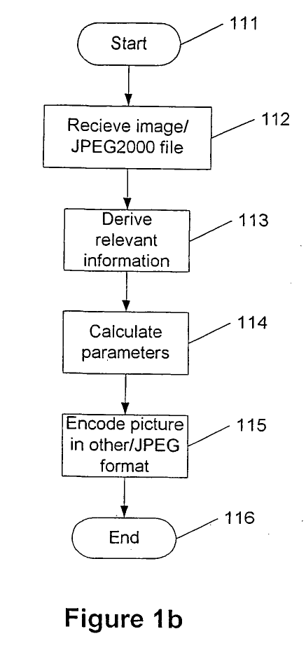

FIG. 2 illustrates a preferred embodiment of the method according to the present invention;

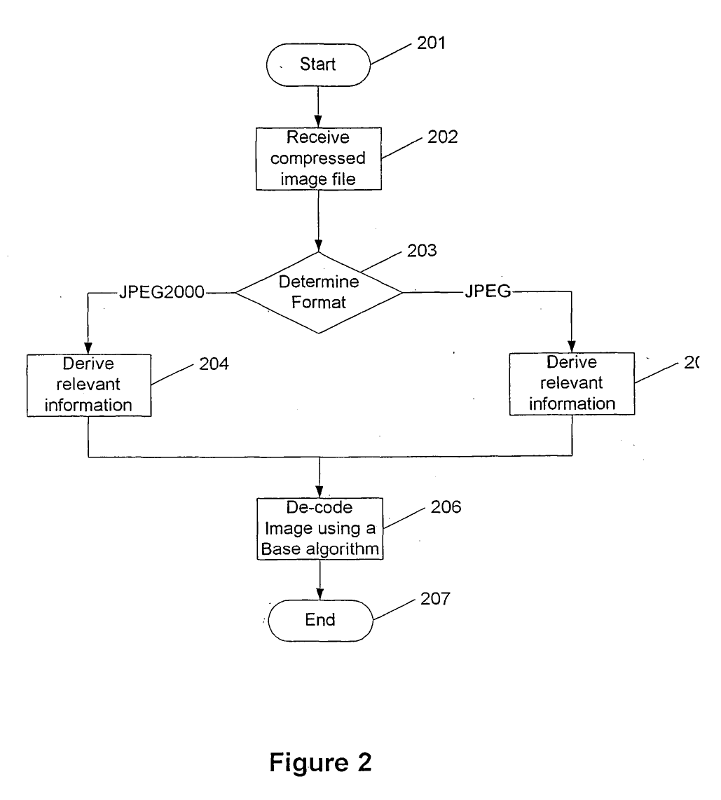

FIG. 3 illustrates a schematic block diagram of an apparatus according to an embodiment of the present invention;

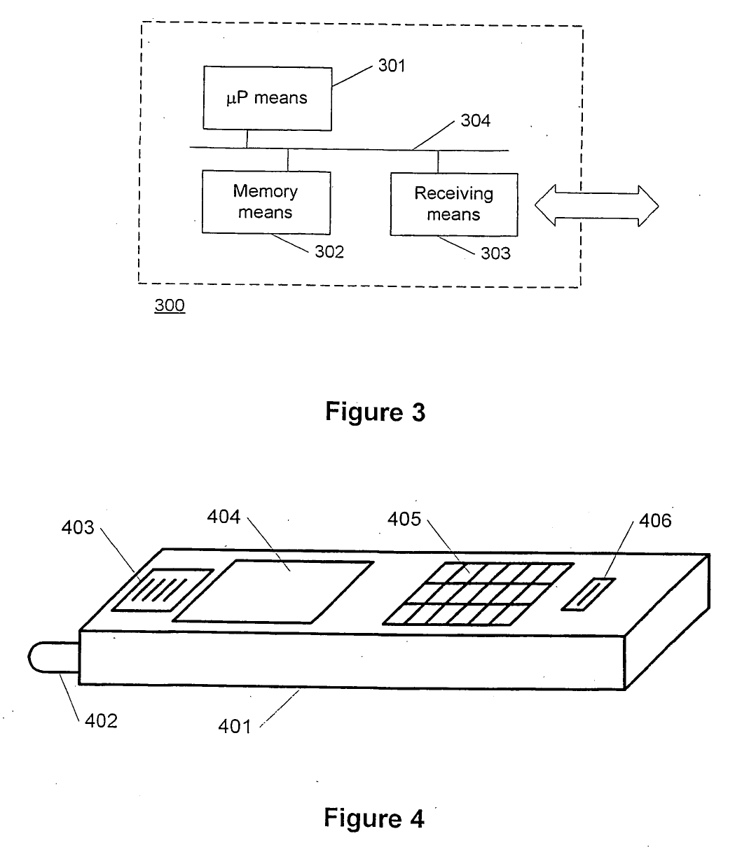

FIG. 4 shows a preferred embodiment of the invention, which may contain the apparatus and/or use the method according to the present invention;

FIG. 1a shows a flow chart of an embodiment of the method according to the present invention illustrating conversion from JPEG to JPEG2000 as an example. This figure illustrates using the present invention to convert an image/image file from one format to another.

The method starts at step (101).

At step (102) image data/a image file is obtained/received, where the image data/image file is in a first format that is to be converted into a second format. Preferably in this example, the image data/file is in a JPEG format.

The received image data/information is data, which may be described by a table/matrix U_{p,q} of size p×q, where each entry (p,q) in the table/matrix comprises information relevant for re-generating/restoring the image/picture again using the appropriate inverse function, which for a JPEG image data file is:

$$IDCT \text{:}$$

$${\hat{Y}}_{m , n} = \frac{4}{{N}^{2}} {\sum }_{p = 0}^{N - 1} {\sum }_{q = 0}^{N - 1} {α}_{q} {α}_{p} {U}_{p , q} cos \frac{π ( 2 m + 1 ) p}{2 N} cos \frac{π ( 2 n + 1 ) q}{2 N} ;$$

This inverse function may be used to decode/uncompress the image data/file directly e.g. for presentation on a display, further processing, transmission, etc.

At step (103) relevant information needed in order to restore the compressed image is derived from the received/obtained image file. The derived relevant information comprises, for this example, the constants α_{q} and _{α}ₚ from the image data/file, i.e. U_{p,q}.

The arrangement, derivation and meaning of U_{p,q}, α_{q} and αₚ are well known in the prior art regarding the JPEG format.

At step (104) parameters, relevant information etc. for the second format, i.e. the format that the image is being converted to, for the image file/data is calculated directly on the basis of the derived information and the received image data/file.

This calculation comprises for this particular example calculating a matrix/table A, where be corresponds to the cosine parts and the constant 4/N\hat{ }2 of the inverse function for the first format/JPEG, that is:

$${A}_{m , n} = \frac{4}{{N}^{2}} cos \frac{π ( 2 m + 1 ) p}{2 N} cos \frac{π ( 2 n + 1 ) q}{2 N} ;$$

This table/matrix may then be stored in a suitable way in suitable memory means.

For this particular example the second format is the JPEG2000 format where a JPEG2000 encoded image may normally be decompressed using the following inverse function:

$$IDWT \text{:}$$

$$y ( p , q ) = {\sum }_{p = 0}^{N - 1} {\sum }_{q = 0}^{N - 1} {U}_{DWT} ( p , q ) {a}^{- \frac{p}{2}} f ( {a}^{- p} t - qT ) .$$

It may be seen that the IDWT and IDCT differs only in the constants and that cosine part are calculated instead of the wavelet function f.

So in order to convert the image data from JPEG to JPEG2000 when A already is calculated is to normalise/equalise the respective constants. That is setting a^{-p/2}=α_{q}αₚ and solving for a for each given p and q.

The resulting constant(s) may be stored in a suitable fashion in suitable memory means, like a suitable table in memory.

At step (105) a new image file/image data is then obtained by using A and the calculated constants thereby deriving the compressed picture data/file according to the second format or more specifically in this particular example thereby deriving the UDWT, which defines an image according to the second format/JPEG2000.

More specifically, this may be done by using an intermediate parameter as:

$${B}_{p , q} = {a}^{- \frac{p}{2}} f ( {a}^{- p} t - q T ) ;$$

where f( . . . ) e.g. may be calculated by the Daubechies 5/3 analysis wavelet, as given in the reference JPEG2000 Image Coding Systems, ISO Final committee draft Version 1.0, March 2000, and a^{-p/2} may be calculated as given above.

The method ends at step (106).

So in this way it is not necessary to decode the image file in the first format completely into an uncompressed image and then code the uncompressed image into the second format, since an image in the second format is calculated directly from the image in the first format using the similarities in the format's respective inverse functions. This reduces the complexity of the system/method and avoids transcoding, which could degrade the image quality.

Additionally, a device comprising the method/steps in FIG. 1a may also receive a picture file in a first format/JPEG and convert it to a second format/JPEG2000, and transmit it to another device, which only supports the second format. This is especially useful in a transition time period when images/pictures largely exists in one format, since only minimum changes/requirements is needed for support of both types.

Alternatively, step (103) and step (104) may be performed in a single step.

FIG. 1b shows a flow chart of another embodiment of the method according to the present invention illustrating conversion from JPEG20000 to JPEG as an example. This example corresponds to the example explained in connection with FIG. 1a but where the conversion is done the other way, i.e. from the second format/JPEG2000 to the first/JPEG in terms of FIG. 1a. Generally, the first format and the second format relates to the format being converted from and the format being converted to, respectively.

The method starts at step (111).

At step (112) image data/a image file is obtained/received, where the image data/image file is in a first format that is to be converted into a second format. Preferably in this example, the image data/file is in a JPEG2000 format.

The received image data/information is data, which may be described by a table/matrix U_{DWT}(p,q) of size p×q, where each entry (p,q) in the table/matrix comprises information relevant for re-generating/restoring the image/picture again using the appropriate inverse function, which for a JPEG2000 image data file is:

$$IDWT \text{:}$$

$$y ( p , q ) = {\sum }_{p = 0}^{N - 1} {\sum }_{q = 0}^{N - 1} {U}_{DWT} ( p , q ) {a}^{- \frac{p}{2}} f ( {a}^{- p} t - qT ) .$$

This inverse function/transform is normally used to decode/uncompress the image data/file directly e.g. for presentation on a display, further processing, transmission, etc.

At step (113) relevant information needed in order to restore the compressed image is derived from the received/obtained image file. The derived relevant information comprises, for this example, the constants a^{-p/2} from the image data/file, i.e. U_{DWT}(p, q)

The arrangement, derivation and meaning of U_{DWT}(p,q) and a^{-p/2} are well known in the prior art regarding the JPEG2000 format.

At step (114) parameters, relevant information etc. for the second format, i.e. the format that the image is being converted to, for the image file/data is calculated directly on the basis of the derived information and the received image data/file.

This calculation comprises for this particular example calculating a matrix/table A*, which corresponds to the wavelet function of the inverse function for the first format/JPEG2000, that is:

A*_{p,q}=f(a^{-P}t−qT)

This table/matrix may then be stored in a suitable way in suitable memory means.

For this particular example the second format—is the JPEG format where a JPEG encoded image may normally be decompressed using the following inverse function:

$$IDCT \text{:}$$

$${\hat{Y}}_{m , n} = \frac{4}{{N}^{2}} {\sum }_{p = 0}^{N - 1} {\sum }_{q = 0}^{N - 1} {α}_{q} {α}_{p} {U}_{p , q} cos \frac{π ( 2 m + 1 ) p}{2 N} cos \frac{π ( 2 n + 1 ) q}{2 N} ;$$

It may be seen that the IDCT and IDWT differs only in the constants and that cosine part are calculated instead of the wavelet function f.

So in order to convert the image data from JPEG2000 to JPEG when A* already is calculated is to normalise/equalise the respective constants. That is setting α_{q}αₚ=a^{p/2} and solving for α_{q}αₚ for each given p and q.

The resulting constant(s) may be stored in a suitable fashion in suitable memory means.

At step (115) a new image file/image data is then obtained by using A* and the calculated constants thereby deriving the compressed picture data/file according to the second format or more specifically in this particular example thereby deriving the U_{p,q}, which defines an image according to the second format/JPEG.

In this way it is not necessary to decode the image file in the first format completely into an uncompressed image and then code the uncompressed image into the second format, since an image in the second format is calculated directly from the image in the first format using the similarities in the format's respective inverse functions. This reduces the complexity of the system/method and avoids transcoding, which could degrade the image quality.

Additionally, a device comprising the method/steps in FIG. 1b may also receive a picture file in a first format/JPEG2000 and convert it to a second format/JPEG, and transmit it to another device, which only supports the second format. This is especially useful in a transition time period when images/pictures largely exists in and equipment uses one format, since only minimum changes/requirements is needed for support of both types.

The method ends at step (116).

FIG. 2 illustrates a preferred embodiment of the method according to the present invention. Shown is a flow chart illustrating a method that support two different image formats having some similarities.

The method starts at step (201).

At step (202) image data/a image file is obtained/received, where the image data/image file is in a first format or a second format that is to be de-coded/de-compressed. Preferably in this example, the image data/file is in JPEG or JPEG2000 format.

For an image file of the JPEG format the image file will directly contain U_{p,q}, describing the image in compressed JPEG format, wherefrom the constants α_{q} and αₚ may be calculated/derived as known from prior art. U_{p,q}, α_{q} and αₚ may normally be used by the IDCT in order to retrieve an uncompressed version of the image.

For an image file of the JPEG2000 format the image file will directly contain U_{DWT}(p,q), describing the image in compressed format, wherefrom the constants a^{-p/2} may be calculated/derived as known from prior art. U_{DWT}(p,q) and a^{-p/2} (together with a relevant wavelet function f) may normally be used by IDWT in order to de-compress/decode the image.

At step (203) a test/determination is made of which format the received/obtained image is in. This test/determination may be performed quite simply, e.g. by looking at a given section in a header of the image file/data.

Dependent of which format the image is in the method proceeds in one of two ways. As an example used to illustrate the method a first format being JPEG2000 and a second format being JPEG are used.

If the test/determination determines that the format of the received image data/file is JPEG2000 then the method proceeds to step (204). If the format of the received image data/file is JPEG the method proceeds to step (205).

At step (204) relevant information relating, in this example, to the JPEG2000 format is determined/obtained. The relevant information is the constants a^{-p/2}, which is directly obtainable according to standard prior art from the image file/image data, i.e. U_{DWT}(p, q), and the following table (like described in connection with FIG. 1b)

A*_{p,q}=f(a^{-p}t−qT)

The relevant constants may be stored in a table, row of a table, vector, one-dimensional array, etc. and the above table may be stored in a table, two-dimensional array, a matrix structure, etc. for later retrieval and use.

At step (205) relevant information relating, in this example, to the JPEG format is determined/obtained. The relevant information is the constants α_{q}αₚ, which is directly obtainable from the image file/image data, i.e. U_{p,q}, and the following table (like described in connection with FIG. 1a)

$${A}_{m , n} = \frac{4}{{N}^{2}} cos \frac{π ( 2 m + 1 ) p}{2 N} cos \frac{π ( 2 n + 1 ) q}{2 N} ;$$

The relevant constants may be stored in a table, row of a table, vector, one-dimensional array, etc. and the above table may be stored in a table, two-dimensional array, a matrix structure, etc. for later retrieval and use.

The obtained constants α_{q}αₚ may be multiplied with the constant 4/N\hat{ }2 prior to storage instead of multiplying with 4/N\hat{ }2 in the expression for A.

At step (206) the image is de-coded/de-compressed using a “base” algorithm/method being similar to the two formats. The base algorithm/method uses a table (either A or A*) and a row/table of constants (either a^{-p/2} or α_{q} αₚ) as input. For support of both the JPEG and JPEG2000 format the base algorithm/method would be according to:

$$Picture ( p , q ) = {\sum }_{p = 0}^{N - 1} {\sum }_{q = 0}^{N - 1} U ( p , q ) \cdot K ( p , q ) \cdot Table ( p , q ) ,$$

for a picture having equal length and height (otherwise one of the sums would go from 0 to M−1 where M is the size of either the length or height and N is the size of either the height or length).

In this expression for the base algorithm/method Picture is the de-coded picture being of size p×q, U(p,q) is the compressed picture information (obtained from the image data/image file), K(p,q) is the constants (e.g. being dependent on p and/or q or even none) derived from the compressed picture information, and Table(p,q) is the table calculated as explained above.

For a compressed image file/compressed image data in JPEG format these would be:

| | |
|---|---|
| U (p, q) | U_{p,q} |
| K (p, q) | $4 / N \hat{} 2 {α}_{q} {α}_{p}$ |
| Table (p, q) | $cos \frac{π ( 2 m + 1 ) p}{2 N} cos \frac{π ( 2 n + 1 ) q}{2 N}$ |

Alternatively, the constant factor 4/N\hat{ }2 may be multiplied to the expression for the Table(p,q) or kept as a separate additional constant.

For a compressed image file/compressed image data in JPEG2000 format these would be:

| | |
|---|---|
| U(p, q) | U_{DWT}(p, q) |
| K(p, q) | a^{-p/2} |
| Table(p, q) | ƒ(a^{-p}t−qT) |

In this way, a single method may support two different compressed image formats having certain similarities like the JPEG and JPEG20000 without having to implement separate individual support for each format, i.e. it is not necessary to have specific JPEG decoder and a JPEG2000 decoder functionality.

Additionally, low complexity image decoding is obtained.

Since only a single transform needs to be implemented a low power consumption is achieved, which is especially important for portable devices/apparatuses like a mobile phone, etc., since the single transform needs less memory and requires less processor instructions (MIPS).

Additionally, backward compatibility to earlier JPEG standard is obtained while maintaining compatibility with the newer JPEG2000 standard. This is done is a very simple way.

Alternatively, more than two formats may be supported as long as the formats have some similarities/common calculations between their individual inverse functions.

FIG. 3 illustrates a schematic block diagram of an apparatus according to an embodiment of the present invention. Shown is an apparatus (300) comprising microprocessor means (301), memory means (302), receiving means (303) and connection means (304) like a bus or the like.

The receiving means (303) is adapted to receive image data/an image file, where the image data/image file is in a first format or a second format that is to be de-coded/de-compressed and/or converted. Preferably, the image data/file is in JPEG or JPEG2000 format.

For an image file of the JPEG format the image file will directly contain U_{p,q}, describing the image in compressed JPEG format, wherefrom the constants α_{q} and αₚ may be calculated/derived as known from prior art. U_{p,q}, α_{q} and αₚ may normally be used by the IDCT in order to retrieve an uncompressed version of the image.

For an image file of the JPEG2000 format the image file will directly contain U_{DWT(p,q)}, describing the image in compressed format, wherefrom the constants a^{-p/2} may be calculated/derived as known from prior art. U_{DWT}(p,q) and a^{-p/2} (together with a relevant wavelet function f) may normally be used by IDWT in order to de-compress/decode the image.

The received information is stored in the memory means (302) via the bus (304) for processing by the microprocessor means (301).

Dependent of which format the image is in the microprocessor means (301) may process the information in a similar way but with different processing steps in order to derive relevant information, parameters, etc. form the received image file/image data. As an example used to illustrate apparatus formats being JPEG2000 and JPEG are used.

If the received image data is in JPEG2000 format the relevant information is the constants a^{-p/2}, which is directly obtainable according to standard prior art from the image file/image data, i.e. U_{DWT(p,q)}, and the following table (like described in connection with FIG. 1b)

A*_{p,q}=f(a^{-P}t−qT)

The relevant constants may be stored in a table, row of a table, vector, one-dimensional array, etc. and the above table may be stored in a table, two-dimensional array, a matrix structure, etc. in the memory means (302) for later retrieval, further processing and use.

If the received image data is in JPEG format the relevant information is the constants α_{q}αₚ, which is directly obtainable from the image file/image data, i.e. U_{p,q}, and the following table (like described in connection with FIG. 1a)

$${A}_{m , n} = \frac{4}{{N}^{2}} cos \frac{π ( 2 m + 1 ) p}{2 N} cos \frac{π ( 2 n + 1 ) q}{2 N} ;$$

The relevant constants may be stored in a table, row of a table, vector, one-dimensional array, etc. and the above table may be stored in a table, two-dimensional array, a matrix structure, etc. in the memory means (302) for later retrieval, processing and use.

The obtained constants α_{q}αₚ, may be multiplied with the constant 4/N\hat{ }2 prior to storage instead of multiplying with 4/N\hat{ }2 in the expression for A.

The stored information, i.e. the constant(s) and the table is de-coded/de-compressed using the microprocessor means (301) by using a “base” algorithm/method being similar to the two formats. The base algorithm/method uses a table (either A or A*) and a row/table of constants (either a^{-p/2} or α_{q} αₚ) as input. For support of both the JPEG and JPEG2000 format the base algorithm/method would be according to:

$$Picture ( p , q ) = {\sum }_{p = 0}^{N - 1} {\sum }_{q = 0}^{N - 1} U ( p , q ) \cdot K ( p , q ) \cdot Table ( p , q ) ,$$

for a image/picture having equal length and height (otherwise one of the sums would go from 0 to M−1 where M is the size of either the length or height and N is the size of either the height or length).

In this expression for the base algorithm/method Picture is the de-coded picture being of size p×q, U(p,q) is the compressed picture information (obtained from the image data/image file), K(p,q) is the constants (e.g. being dependent on p and/or q or even none) derived from the compressed picture information, and Table(p,q) is the table calculated as explained above.

For a compressed image file/compressed image data in JPEG format these would be:

| | |
|---|---|
| U (p, q) | U_{p,q} |
| K (p, q) | $4 / N \hat{} 2 {α}_{q} {α}_{p}$ |
| Table (p, q) | $cos \frac{π ( 2 m + 1 ) p}{2 N} cos \frac{π ( 2 n + 1 ) q}{2 N}$ |

Alternatively, the constant factor 4/N\hat{ }2 may be multiplied to the expression for the Table(p,q) or kept as a separate additional constant.

For a compressed image file/compressed image data in JPEG2000 format these would be:

| | |
|---|---|
| U(p, q) | U_{DWT}(p, q) |
| K(p, q) | a^{-p/2} |
| Table(p, q) | ƒ(a^{-p}t−qT) |

In this way, a single transform implemented in the apparatus (300) may support two different compressed image formats having certain similarities like the JPEG and JPEG2000 without having to implement separate individual support for each format, i.e. it is not necessary to have specific JPEG decoder and a JPEG2000 decoder functionality.

Additionally, low complexity image decoding is obtained.

Since only a single transform needs to be implemented a low power consumption is achieved, which is especially important for portable devices/apparatuses like a mobile phone, etc., since the single transform needs less memory and requires less processor instructions (MIPS).

Additionally, backward compatibility to earlier JPEG standard is obtained while maintaining compatibility with the newer JPEG2000 standard. This is done is a very simple way.

Alternatively, more than two formats may be supported as long as the formats have some similarities/common calculations between their individual inverse functions.

FIG. 4 shows a preferred embodiment of the invention, which may contain the apparatus and/or use the method according to the present invention. Shown is a mobile telephone (401) having display means (404), input means (405) like a keypad, touch screen, etc., an antenna (402), a microphone (406), and a speaker (403). By including the apparatus and/or use the method according to the present invention, simple support of two different compressed image formats having certain similarities like the JPEG and JPEG2000 without having to implement separate individual support for each format. Additionally, low complexity image decoding is obtained and since only a single transform needs to be implemented a low power consumption is achieved since the single transform needs less memory and requires less processor instructions (MIPS).

Additionally, backward compatibility to earlier JPEG standard is obtained while maintaining compatibility with the newer JPEG-OOO standard. This is done is a very simple way.

1. A method of supporting a first and a second image format, the method comprising the steps of
obtaining image data in the first image format or in the second image format from a compressed image, and
deriving relevant information on the basis of the obtained image data,
characterized in that the method further comprises the step of
applying a base function to at least part of the obtained image using at least part of the derived relevant information, where the base function is a function common to both the first and the second image format.

2. Method according to claim 1, characterized in that the first format and/or second format is selected from the group of: JPEG and JPEG2000.

3. Method according to claim 1 or 2, characterized in that the step of deriving relevant information comprises at least one of
deriving at least one constant on the basis of the obtained image data, and
deriving at least one table on the basis of the obtained image data.

4. Method according to any one of claims 1-3, characterized in that the step of deriving relevant information comprises deriving information relating to the inverse transform according to the first and/or second format.

5. Method according to any one of claims 3-4, characterized in that
the format of the image is JPEG being able to be decoded by the inverse discrete cosine transform (IDCT),
the step of deriving relevant information comprises deriving at least one constant using the constant parts of the IDCT and the image data, and deriving a table using the cosine parts of the IDCT and the image data.

6. Method according to any one of claims 3-5, characterized in that
the format of the image is JPEG2000 being able to be decoded by the inverse discrete-wavelet transform (IDWT),
the step of deriving relevant information comprises deriving at least one constant using the constant parts of the IDWT and the image data, and deriving a table using the wavelet function part(s) of the IDWT and the image data.

7. Method according to any one of claims 1-6, characterized in that the base function is done by applying two sums one from index 0 to N-1 and one from index 0 to M−1 on the at least one derived constant, the derived table, and the image data, where N and M is equal to the length and the height of image, respectively.

8. A method of converting between a first and a second image format, the method comprising the steps of
obtaining image data in the first image format from a compressed image, and
deriving relevant information on the basis of the obtained image data,
characterized in that the step of deriving relevant information comprises
deriving at least one first constant according to the inverse transform of the first image format and using the image data, and
deriving at least one first table according to the inverse transform of the first image format,
and in that the method further comprises the step of
deriving at least one second constant according to the inverse transform of the second image format and using the at least one first constant,
and deriving at least one second table according to the inverse transform of the second image format using the at least one first table.

9. Method according to claim 8, characterized in that
the first image format is JPEG and the second image format is JPEG2000, or
the first image format is JPEG2000 and the second image format is JPEG.

10. A method according to any one of the claims 1-9, characterized in that said method is used in a portable device.

11. A method according to any one of the claims 1-10, characterized in that said method is used in a mobile telephone.

12. A computer-readable medium having stored thereon instructions for causing a processing unit to execute the method according to any one of claims 1-11.

13. A computer system comprising means adapted to execute a program, where the program, when executed, causes the computer system to perform the method according to claims 1-11.

14. An apparatus for supporting a first and a second image format, the apparatus comprising
receiving means (303) for receiving image data in the first image format or in the second image format from a compressed image, and
processing means (301) for deriving relevant information on the basis of the obtained image data,
characterized in that the processing means (301) further is adapted to
apply a base function to at least part of the obtained image using at least part of the derived relevant information, where the base function is a function common to both the first and the second image format.

15. Apparatus according to claim 14, characterized in that the first format and/or second format is selected from the group of: JPEG and JPEG2000.

16. Apparatus according to claim 14 or 15, characterized in that processing means (301) is adapted to derive relevant information by
deriving at least one constant on the basis of the obtained image data, and/or
deriving at least one table on the basis of the obtained image data.

17. Apparatus according to any one of claims 14-16, characterized in that processing means (301) is adapted to derive relevant information by deriving information relating to the inverse transform according to the first and/or second format.

18. Apparatus according to any one of claims 16-17, characterized in that
the format of the image is JPEG being able to be decoded by the inverse discrete cosine transform (IDCT),
that processing means (301) is adapted to derive at least one constant using the constant parts of the IDCT and the image data, and deriving a table using the cosine parts of the IDCT and the image data.

19. Apparatus according to any one of claims 16-18, characterized in that
the format of the image is JPEG2000 being able to be decoded by the inverse discrete wavelet transform (IDWT),
that processing means (301) is adapted to derive at least one constant using the constant parts of the IDWT and the image data, and deriving a table using the wavelet function part(s) of the IDWT and the image data.

20. Apparatus according to any one of claims 14-19, characterized in that the base function is done by applying two sums one from index 0 to N−1 and one from index 0 to M−1 on the at least one derived constant, the derived table, and the image data, where N and M is equal to the length and the height of image, respectively.

21. An apparatus for converting between a first and a second image format, the apparatus comprises
receiving means (303) for obtaining image data in the first image format from a compressed image, and
processing means (301) for deriving relevant information on the basis of the obtained image data,
characterized in that the processing means (301) further is adapted to
derive at least one first constant according to the inverse transform of the first image format and using the image data,
derive at least one first table according to the inverse transform of the first image format,
derive at least one second constant according to the inverse transform of the second image format and using the at least one first constant, and
derive at least one second table according to the inverse transform of the second image format using the at least one first table.

22. Apparatus according to claim 21, characterized in that
the first image format is JPEG and the second image format is JPEG2000, or
the first image format is JPEG2000 and the second image format is JPEG.
